(19) United States
(12) Patent Application Publication
(10) Pub. No.: US 2024/0240119 A1
(43) Pub. Date: Jul. 18, 2024

(54) BEVERAGE AND FOOD PRODUCTION

(71) Applicant: UGO FOODS GROUP LIMITED, Borehamwood, Hertfordshire (GB)

(72) Inventor: Charles UGO, Borehamwood (GB)

(73) Assignee: UGO FOODS GROUP LIMITED, Borehamwood, Hertfordshire (GB)

(21) Appl. No.: 18/562,311

(22) PCT Filed: May 19, 2022
(86) PCT No.: PCT/IB2022/054698

§ 371 Date: Nov. 18, 2023

(30) Foreign Application Priority Data
May 19, 2021 (GB) 2107200.4

(51) Int. Cl. C12G 3/021; A23L 5/10; A23L 7/109; C12C 7/047

(52) U.S. Cl. CPC C12G 3/021; A23L 5/13; A23L 7/109; C12C 7/047

(57) ABSTRACT

The invention relates to beverage and food production. It provides a novel process for the production of an improved beer-like beverage which is unprecedented in humankind's seven thousand years of beer-making history. As well as providing a pleasant tasting beer, the process is suited to integration with food-production leading to a reduction in food waste and greater efficiency. Aspects provide a beer and a production line, with a collection arrangement for collecting surplus or reject pasta for use in the novel process.

The present invention relates to food and beverage production. In particular the invention relates to a novel method of producing a beer or similar drink and to improved food and beverage production methods. As well as providing a pleasing product, methods and apparatus may reduce food waste, and also may reduce energy consumption in the beverage production process, both of which are important environmental concerns.

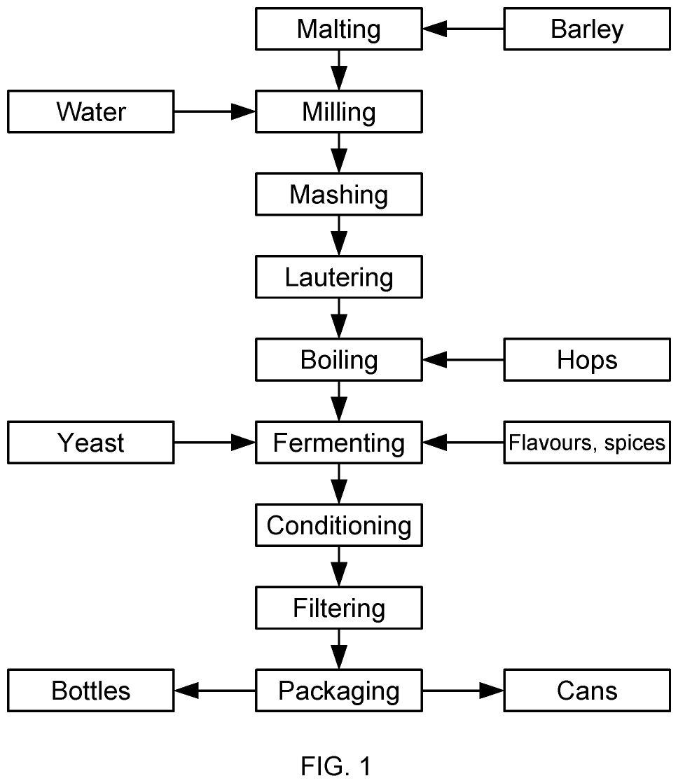

Beer has been known since approximately the 5^{th} millennium BC or about 7000 years, produced by fermenting of crops such as barley, malt, hops or in some cases wheat. There are currently about 20,000 brands of beer and annual consumption is close to 200 billion litres a year. The conventional beer making process is explained below with reference to FIG. 1.

Notwithstanding the very long history, the inventors have arrived at a novel method of producing a beer-like beverage.

According to a first aspect, the invention provides a method of forming a beverage comprising:
providing a supply of grain comprising wheat and/or semolina in the form of a milled dry grain flour;
forming the grain flour into a dough;
extruding the dough or otherwise shaping the dough under pressure;
at least partially cooking the extruded dough in a moist saturated steam environment with steam at a temperature of at least 90 degrees Celsius so that starch in the grain at least partially gelatinizes;
mashing the steam treated dough into a wort;
fermenting the gelatinized mashed grain with yeast and water to provide an alcoholic beverage.

Without wishing to be bound by any theory, by subjecting the grain after dry milling and forming into dough to steam rather than extended exposure to liquid including heating with the grain soaked in liquid prior to mashing, the wheat or semolina has a different texture. Moreover certain components which tend to be leached out or degraded are retained leading to a subtly different but pleasing blend of flavours in the finished beverage with less processing time. When the grain as a dough is subjected to steam rather than being immersed and heated in water initially, the degradation and undesirable taste effects can be reduced. Moreover reducing the starches may also beneficially reduce the non-alcohol calorie content of the beer.

The temperature is preferably below 100 degrees. The pressure is preferably ambient atmospheric. However it is possible to use elevated pressure, in which case the steam temperature may in some cases be a little over 100 degrees.

Preferably the grain is heated for at least 1 minute and/or so that at least 5% by weight of the starch gelatinizes. More preferably the grain should be heated for between 1.5 and 2.5 minutes to maximise starch gelatinization.

The mashed wort may be boiled and hopped including adding desired flavours and aromas prior to fermenting.

The temperature is preferably less than 100 degrees and above 90 degrees Celsius. More preferably the temperature is above 92 degrees and less than 98 degrees and the process is performed substantially at atmospheric pressure. The humidity of the atmosphere during the heating stage should preferably be 100% saturated.

Preferably the grain is dry milled into a flour prior to cooking and prior to exposure to water. Milling changes the physical structure so makes the grain more susceptible to steam treatment. It can also lead to a purer product with fewer undesirable flavours and also a smaller quantity of potential pollutants.

Preferably the grain is provided as a flour and sufficient water is added to form the grain into a dough and then the dough is subjected to steam treatment. Forming a dough subjects the milled flour to exposure to a limited amount of water prior to cooking which may have the advantage of improving the flavour and composition of the resulting beverage. The mass of liquid per quantity of mixed dough should not exceed 40% the mass of the flour in each quantity of mixed dough. More preferably the mass of liquid in each quantity of mixed dough should be between 25% and 35% of the mass of flour in each quantity of mixed dough. The liquid is preferably 100% ambient water, but may include a small quantity of other liquids, typically proteinous liquids such as egg to enhance the starch gelatinization process.

Preferably the dough is extruded, for example in the manner of a pasta, prior to steam cooking. Extruding the dough affects the surface area and may advantageously affect the distribution of gelatinized and raw starches after cooking. This may also be achieved through other means of pressure shaping such as high pressure lamination. Preferably the pressure exerted should exceed 40 bar solid pressure. More preferably the pressure exerted should be between 50 bar and 100 bar solid pressure. References to being formed under pressure are not limited to such pressures however and actual pressures need not be measured—the act of forcing the dough through an orifice or to be shaped comprises forming under pressure.

Preferably the partially steam cooked gelatinized dough mixture is then mashed, lautered, boiled and hopped, and fermented to produce an alcoholic beverage with an alcohol content of at least 2%, preferably fermenting for at least 48 hours. The mashing process may also allow the introduction of other malted grains as is the case for known brewing processes.

Techniques from known brewing processes, particularly for wheat beers may be employed to this novel brewing starting point, including addition of hops, flavourings and subsequent processing and filtering processes.

However, it is found that because the initial ingredients are relatively refined with potential pollutants and starches removed, the beverage may require less post fermentation treatment than conventional beers to be acceptably pure and pleasantly drinkable.

Mashing will preferably be performed with gelatinized dough particulate below 30 mm. More preferably the particulate size should be between 3 mm and 20 mm. The mashing process should preferably be performed with a mixture of distilled water and gelatinized dough particulates with a ratio of approximately 4:1 water to dough. Other malted grains may be included at this stage. The mixture should be heated to a temperature of preferably less than 70 degrees Celcius for preferably more than 30 minutes. More preferably the temperature and timings should be such as to maximise enzyme activity. This will be different for different flour types, but should generally be at between 63 and 69 degrees Celcius for between 50 and 70 minutes. Ideally the temperatures will follow a specific process, stopping for specific intervals at particular temperatures to further maximise enzyme activity with the specific sugars. For ideal enzyme activity, the specific grain make up will require specific target temperatures and intervals.

Lautering is the process of removing the excess remaining dough to leave a liquid residue containing fermentable sugars known as the wort. This will preferably yield up to 90% of liquid per quantity of initial added water. The addition of other grains in the mashing process will alter this yield accordingly. Particular care should be taken as to ensure minimal loss of fermentable sugars during lautering.

Preferably boiling of the lautered mash should be undertaken to sterilise the liquid prior to fermentation. Boiling should preferably be at least 45 minutes and no more than 2 hours. Hops and other flavourings may be added during the boiling process. Preferably with hops added early in the boiling process, boiling should be approximately 60 minutes.

Following the boiling process, the mixture is rapidly cooled, preferably down to 25 degrees Celsius within 30 minutes. The yeast may then be added and the mixture left to ferment. Known brewing processes may be applied but preferably the mixture will be fermented for at least 2 days and more preferably for up to 2 weeks due to the high level of sugars available for fermentation. Preferably the yeast will be fermented at between 10 and 26 degrees Celsius. More preferably the yeast will be fermented at specific temperature ranges for specific beer styles.

All other further process are alike known brewing processes, such as conditioning, filtering, kegging, bottling and otherwise packaging the final product.

In a preferred embodiment, the invention thus provides a method of making a beer-like beverage comprising:
providing grain comprising wheat or semolina in milled form as a flour;
mixing the grain with sufficient water to form a dough;
extruding the dough or otherwise shaping the dough under pressure;
subjecting the extruded or otherwise shaped dough to cooking in saturated steam at a temperature of at least 90 degrees Celsius for at least one minute to cause at least partial gelatinization of starch contained within the grain;
cutting the extruded cooked dough;
mixing the cut extruded cooked dough with water and mashing to convert the starches from the gelatinized dough into fermentable sugars;
producing a brewing mixture from the mixed extruded cut dough;
fermenting the brewing mixture to produce an alcoholic beverage.

Preferably fermented at a temperature of between 10 and 26 degrees Celsius for at least 2 days to produce an alcoholic beverage with an alcohol content of at least 2%, preferably at least 3%.

Producing a brewing mixture typically comprises lautering to extract the remaining grain and leave the required wort; boiling the wort to sterilise any potential pathogens and simultaneously adding hops and other flavourings to add aromas as desired; and mixing the hopped boiled wort with yeast to produce a brewing mixture.

In a second aspect the invention provides an alcoholic beverage comprising alcohol obtained from fermenting milled steam-cooked grain and residual steam-cooked grain derivatives.

Such a beverage may be distinguished from conventional beers by analysis of the sugars and residual components of the beverage.

In a preferred embodiment, the grain is processed substantially as if it were going to be formed into a pasta in the initial steps and is then subsequently used to form a brewing mixture.

This conveniently allows the beverage forming production process to be integrated with a food production process with a saving in waste and energy.

According to a third aspect the invention provides a method of producing a food product and a beverage comprising:
providing a supply of milled grain flour;
forming a dough from the milled grain flour by addition of water;
extruding the dough or otherwise shaping the dough under pressure;
subjecting the dough to at least partial cooking in saturated steam at a temperature of at least 90 degrees Celsius;
forming a pasta-like product from a first portion of the cooked extruded dough;
providing a second portion of the cooked extruded dough to a fermentation process to produce an alcoholic beverage.

In a conventional pasta making process, there is typically some wastage. Some pasta may be mis-formed or some wastage may occur in filling or subsequent processing. In lower quality pasta-making factories the sub-optimal pasta is simply mixed in with the rest. However, in very high-quality operations, such as the applicant's, which strives to provide only the finest quality pasta which is both aesthetically and gastronomically excellent there can be a significant degree of wastage, which varies depending on the type of pasta being produced.

Preferably at least some of the second portion is provided by collecting surplus or reject pasta from a further processing step of forming the pasta into a finished product.

However, the beverage making process, where the grain is chopped and then mixed with water and dissolved and fermented is unaffected by the initial shape of the product and thus can make use of reject pasta at various points along the production line, from initial shaping to cutting to packaging. Thus by combining the two processes, food waste is reduced, which is both economically beneficial and good for the planet.

In a related fourth aspect the invention provides a production line for producing a pasta-like product comprising:
an extruder for extruding pasta dough into a pasta-like food product or a sheeter/laminator to produce a thin sheet of pasta dough under pressure for use in pasta-like food products;
a saturated steam cooking station for at least partially cooking the pasta-like food product;
at least one further processing station comprising as cutting, filling or packaging station for further processing the cooked pasta-like food product;
a collecting arrangement for collecting surplus or reject pasta from the at least one further processing station to supply to a wort producing and fermenting process.

In both the method and apparatus, control may be provided for monitoring the level of surplus or reject pasta from the pasta making process and/or estimating an expected level of surplus or reject and controlling the amount of grain specifically directed to providing the second portion.

Embodiments of the invention will now be particularly described with reference to the accompanying drawings, in which:—

FIG. 1 shows schematically, an overview of a conventional beer-making process;

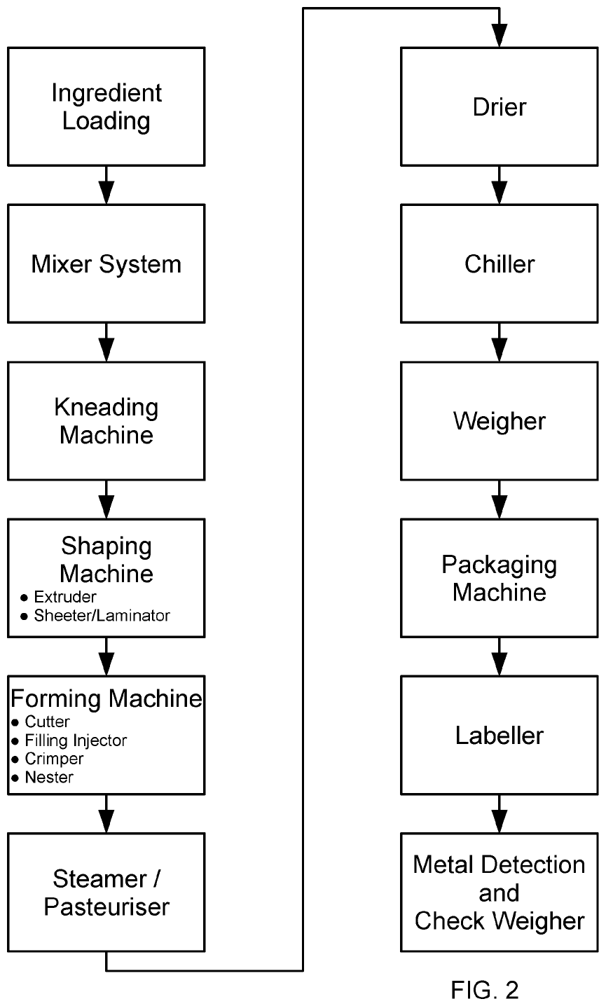

FIG. 2 shows schematically a pasta production line;

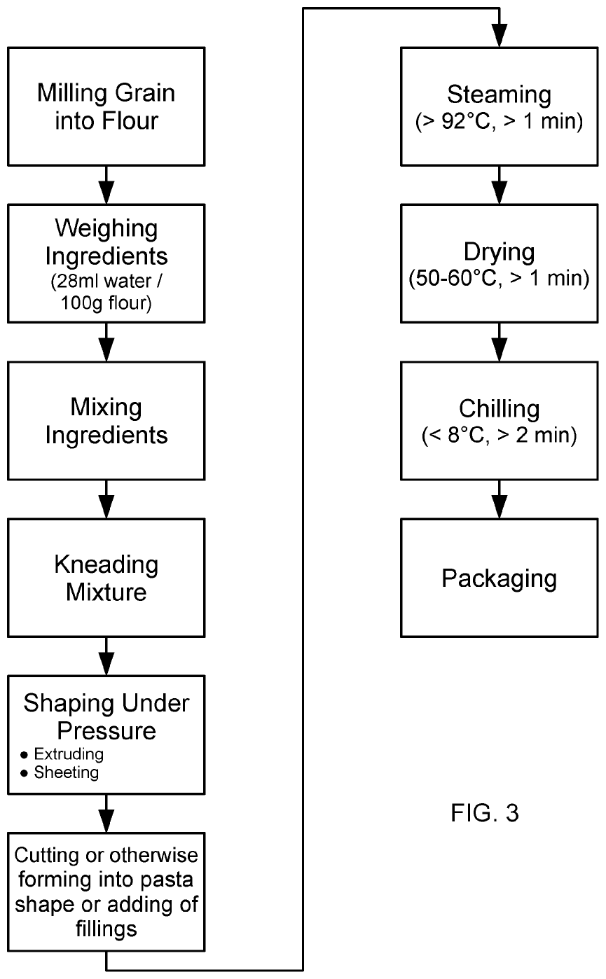

FIG. 3 shows schematically, a flowchart of a fresh pasta-forming process;

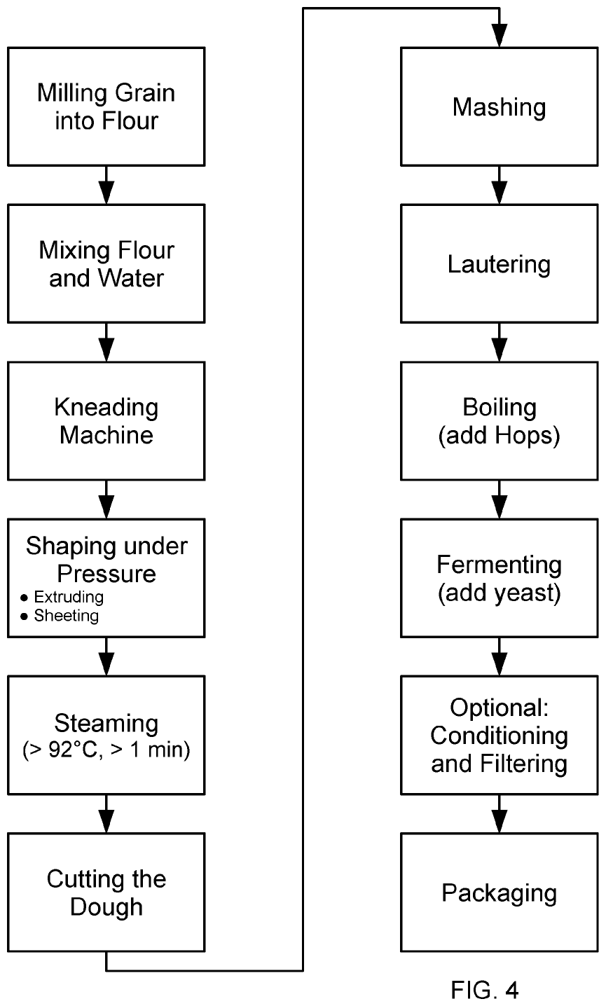

FIG. 4 shows schematically a flowchart of a beverage forming process according to a first embodiment;

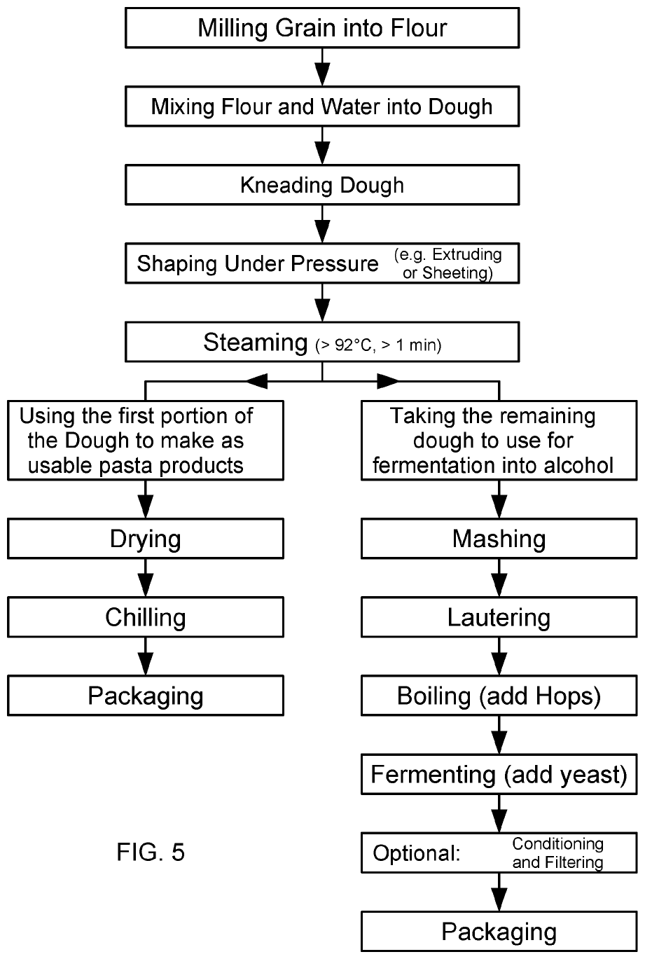

FIG. 5 shows schematically a combined pasta and beverage production line according to a second embodiment;

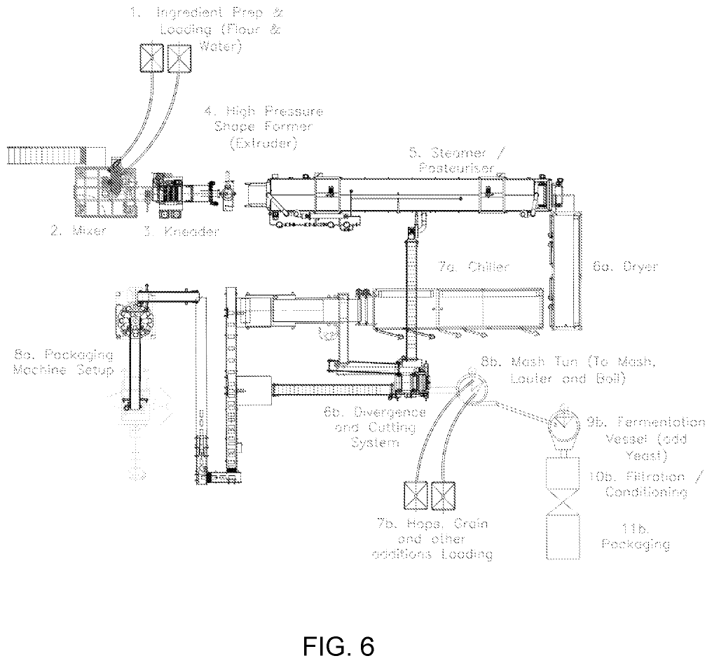

FIG. 6 shows a technical layout drawing of a combined pasta and beverage production line according to a second embodiment, referencing the schematic flow in FIG. 5.

Referring to FIG. 1, a conventional beer-making process is depicted. The basic steps involved are as follows:—
1. Malting: Here the conversion from carbohydrates to dextrin and maltose takes place. The grain used as the raw material is usually barley. Barley as a cereal can be preserved for a long time after harvesting and it is the malted barley that conventionally gives beer its characteristic colour and taste. Malting is accomplished by soaking the barley or other grain in water and allowing time for the starch to break down. The malt is then kilned or heated in a kiln to dry it and to break down sugars and it may be roasted. The degree of heating may determine the type of beer from a light beer to a dark beer.
2. Milling: The malt is milled or ground then again mixed with water to complete the conversion of starches in the grain to sugar, consistency to the malt. Note that the grain is milled after treatment with water and is again treated with water.
3. Mashing: This process converts the starches released during the malting stage, into sugars that can be fermented. Here the liquid is heated typically to a temperature in the region of 58 to 78 degrees centigrade to break down starch into simpler sugars. Heating often involves pausing at certain temperatures where particular enzymes are effective or processes occur, typically 45, 62 and 73 degrees centigrade or 113, 144 and 163 F.
4. Lautering: The liquid containing the sugar extracted during mashing is now separated from the grains. It is then generally termed as wort.
5. Boiling and Hopping: Boiling the wort, ensures its sterility, and thus prevents a lot of infections. Hops are added during this stage of boiling. Hops are used to add flavour and aroma to balance the sweetness of the malt. The mixture is often boiled for between 30 minutes and 2 hours, typically an hour. This boiling process dissolves some hop resins and allows some alpha acids to isomerize to become soluble.
6. Fermenting: The yeast is now added and the Beer is fermented. The yeast breaks down the sugars extracted from the malt to form alcohol and CO2.
7. Conditioning: Fermented Beer contains suspended particles, lacks sufficient carbonation, lacks taste and aroma, and less stable. Conditioning reduces the levels of these undesirable compounds to produce a more finished product.
8. Filtering: Filtration helps to remove excess of the yeast and any solids, like hops or grain particles, remaining in the Beer. Filtering is the process which produces the clear, bright and stable Beer.
9. Packaging: Packaging is putting the beer into the bottles, cans or some other high volume vessels. One of the most important things in packaging is to exclude oxygen away from the Beer.

Referring to FIGS. 2 and 3 a basic pasta forming process is explained. The basic steps involved are as follows:—
1. Milling: Initially a grain must be milled into a suitable flour.
2. Weighing: the ingredients of typically water and flour must be weighed. The approximate preferable recipe is 28 ml water per 100 ml flour.
3. Mixing: The ingredients must be mixed to form a dough.
4. Kneading: The dough should be kneaded to ensure gluten proteins are sufficiently worked to provide elasticity to the final product.
5. Shaping: The dough must then be shaped under pressure. During the shaping process, ingredients are mixed, conditioned, and transformed to a partial fluid, thus causing a release of functional compounds because of structural and chemical changes. This is caused due to the effects of temperature, moisture content, pressure and geometrics of the shaping apparatus.
   a. Extruding: able to exert higher pressure.
   b. Sheeting/Lamination—standard in filled pasta production, leaves the dough more malleable with less shape memory.
6. Cutting or Forming: depending on required pasta shape or product this is a variable process.
7. Steaming: partially cooking the dough in saturated steam at a temperature of at least 92 degrees centigrade for at least one minute to cause at least partial gelatinization of starch contained within the grain ensures better product strength, and also removes pathogens and any microbial contaminants to provide a significantly extended life of product.
8. Drying: drying the formed steamed dough removes surface moisture and prevents excess water content ending up in packaging
9. Chilling: cooling the dried product down to <8 C allows it to be packaged and refrigerated without causing condensation in the packaging.
10. Packaging: weighing and packaging the product can take many forms, including the use of modified atmosphere packaging to extend life. Critically the removal of oxygen and replacement with CO2 is critical for organoleptic life of the product.

Referring to FIG. 3, a typical pasta making process is explained. Note that in contrast to conventional beer making, a relatively small amount of water is mixed with the flour to form a dough. In the example given 28 ml of water is mixed with 100 g of flour. Preferably a mass of water less than half the mass of flour is mixed with the flour, more preferably less than one third of the mass of flour is mixed with the flour, to give a dough like consistency.

This contrasts with beer-making where the grain is exposed in processing to considerably more than its own mass of water before being heated.

Referring to FIG. 4, an exemplary process for forming a beverage according to the novel process of an embodiment will now be described:—
1. Milling: Initially a grain of preferably wheat or semolina flour must be milled and ideally de-branned to ensure a consistent grain size, colour and hardness. This is a raw milling process unlike in known brewing processes where grain is first malted before being milled down where necessary.
2. Mixing: The milled grain should then be mixed with liquid, preferably but not necessarily 100% water, until the dough is consistent.
3. Kneading: Preferably the dough should be kneaded to ensure gluten proteins are sufficiently worked to provide elasticity and strength prior to shaping. This may also make the dough more susceptible to gelatinization of starches under the steaming process.
4. Shaping: The dough must then be shaped under pressure, preferably extrusion. During the shaping process, ingredients are mixed, conditioned, and transformed to a partial fluid, thus causing a release of functional compounds because of structural and chemical changes. This may include the pre-gelatinization of starches to further enhance the additional steam process. This is caused due to the effects of temperature, moisture content, pressure and geometrics of the shaping apparatus.
5. Steaming: partially cooking in saturated steam at a temperature of at least 92 degrees centigrade for at least one minute to cause at least partial gelatinization of starch contained within the grain, and also removes pathogens and any microbial contaminants. The at least partial gelatinization of starches contained within the grain is what allows the output product to be used in fermentation to alcohol. This process fundamentally replaces the Malting process used in known brewing processes, as a standard way of converting the starches in the grains from carbohydrates to dextrin and maltose which can subsequently be used with yeast to ferment and produce an alcoholic beverage. As a totally new process in brewing, this changes the potential methods of extracting sugars for fermentation from grains. As such this should increase the potential yield of crops for alcohol production as a net total.
6. Cutting: the steamed shaped dough is then cut into appropriate particulate sizes of preferably 5-20 mm. This allows ideal surface area vs volume conditions for the mashing process.
7. Mashing, Lautering, Boiling, Fermenting, Conditioning, Filtering and Packaging: These processes can substantially follow existing known brewing processes, treating the cut steamed shaped dough as if it were a malted grain.

The significant difference to standard brewing processes is that the combination of milling grain, mixing with water, applying pressure and partially steam cooking acts as an alternative to the malting milling process prior to mashing in known brewing processes. Surprisingly although the texture of the steamed shaped dough is very different from malted grains, the steamed shaped dough ferments well when treated similarly to a malted grain with the added surprising benefit that the subtle changes caused by partial gelatinization of the starches in the steam treatment can give a more pleasing flavour.

Referring to FIG. 5, an embodiment of a modified production line will now be explained.

As the initial process for pasta production and the novel proposed brewing process are coincidentally identical, it allows for the combination of processes to collect unused pasta and weight rejection pasta for the raw ingredient of the brewing process to both simultaneously reduce waste and produce a novel new method of producing alcohol.

While the process of producing pasta products will always produce some waste, the ability to use this waste for a further process to produce a saleable product should allow for higher level quality control over pasta production with the certainty that raw material usage will be maintained, but for a different final product. This further encourages control and monitoring of waste data to predict alcohol beverage output vs pasta production to allow for targeted stock replenishment, rather than focus on cost reductions via pure waste reduction which could potentially have impacts on quality. Where combined production lines are provided, a bypass path may be provided so that the beverage making process is continuously fed with variations in the amount of waste collected being accommodated by complementary variations in the bypass supply.

Almost all ‘unusable waste’ from pasta production comes from post steam processes which therefore is perfectly usable in the novel proposed brewing process. Existing waste collection points such as belt transfer points and cutting stations can be used to collect waste for the purpose of fermentation. ‘Unusable waste’ pre steam processes may also be collected and be separately steamed during production downtime. Waste contaminated with other ingredients such as egg may be used if separated from ‘clean’ waste, to produce a unique product of egg containing beer for example. This allows for full waste collection, monitoring and management of a pasta production facility to produce a range of unique brewed alcoholic beverages while improving quality control on pasta production and simultaneously reducing food waste and therefore reducing environmental impact both due to the waste reduction but also the fact that no malted grain needs to be produced to create the output alcoholic beverage.

A controller may adjust the amount of steamed formed pasta directed to bypass the pasta production process. The controller may use logic with a machine learning engine to predict waste based on the process parameters and recipe and to adjust bypass production accordingly.

A particular advantage of the combined production method and production line is that “waste” is no longer waste and even more stringent quality control can be applied as an increase in rejected material simply provides a higher level of supply to the beverage production process. In a further aspect, the invention provides a production line for forming pasta from steam cooked dough through a series of processing stations, the production line has a quality control process arranged to reject partially formed pasta at one or more processing stations according to one or more quality criteria, wherein the rejected partially formed pasta is supplied as a feed to a beverage making process and wherein the quality criteria are set to target a positive non-zero proportion of rejected partially formed pasta.

In general processes are normally adjusted to target zero waste. The target proportion of rejected partially formed pasta may be at least 1% of total production.

The production line may involve a pasta filling station for forming filled pasta and the production line may include a controller arranged to apply more stringent quality control criteria upstream of the pasta filling station to target a positive non-zero proportion of rejected partially formed pasta and to target a smaller or zero proportion of rejected partially formed pasta downstream of the filling station. In this way, if it is found that more stringent quality control upstream leads to lower rejection downstream, a smaller proportion of the pasta will be rejected after filling, which may complicate processing the pasta to form into a beverage. Depending on the filling, small amounts of filling may be tolerated and indeed may even be added (or components thereof added) to give a flavour to the beverage.

In a further aspect, the invention provides a method of forming a packaged meal having a pasta component and an alcoholic beverage component comprising producing pasta from a steamed cooked grain supply and producing a beverage by fermenting a brewing mixture also formed from the steamed cooked grain supply, separately packaging the pasta and beverage into respective sealed pasta and drink containers, and subsequently packaging the sealed pasta and drink containers into a combined meal package.

Recipes for both pasta and beer are well known. Final products can be made according to traditional or novel recipes as will be well known and the invention is not limited to any particular recipe or flavouring. Whereas existing beer recipes and formulations may be used directly simply substituting the quantity of malted grain for the formed cooked pasta, taking into account the mass of water in each, it is envisaged that the skilled reader will adjust recipes to taste and to take advantage of the subtly different flavour resulting from the novel process. Moreover, while conventional brewing processes are described to aid understanding, the novel process may be applied to modified or novel beer-making processes substituting the initial grain malting process. In a further aspect, the invention provides a brewing mixture or brewing mixture precursor comprising a steamed milled grain flour formed and shaped under pressure and mixed with water.

As will be appreciated from the foregoing, the beverage making process, production line, beverage and precursor and final packaged product are all inter-related. Whereas each may be independently provided, equally preferred features and refinements of each may be applied to the others. Optional and preferred features of each element or aspect may thus be applied to each aspect and different aspects may be combined.

1. A method of forming a beverage comprising:
providing a supply of grain;
forming the flour into a dough;
processing the dough;
at least partially cooking the processed dough in a moist steam environment with steam at a temperature of at least 90 degrees and less than 100 degrees Celsius so that starch in the grain at least partially gelatinizes to form a gelatinized dough mixture;
forming a brewing mixture from the gelatinized dough mixture;
fermenting the brewing mixture to provide an alcoholic beverage.

2. A method according to claim 1 wherein the grain is provided in milled form as a flour.

3. A method according to claim 2 comprising mixing the grain with a sufficient quantity of water to form a dough and processing the dough comprises processing the dough into shaped fragments formed under pressure prior to said at least partially cooking.

4. A method according to claim 3 wherein processing the dough comprises extruding or sheeting and laminating the dough as a pasta-like shape.

5. A method according to claim 3 wherein the dough is cooked for between 1 and 2 minutes at a temperature of between 92 degrees Celcius and 98 degrees Celcius and a pressure of substantially atmospheric pressure so that >2% percent by weight of starch within the grain gelatinizes.

6. A method according to claim 1 comprising obtaining at least some of the cooked dough as surplus or reject from a pasta production line.

7. A method according to claim 1 further comprising chopping or fragmenting the cooked grain and adding between 1 and 30% by weight of grain to water and adding yeast prior to said fermenting.

8. A method according to claim 1 wherein forming a brewing mixture comprises mashing, lautering and boiling the gelatinized dough mixture and mixing with yeast and water.

9. A method according to claim 1 wherein the beverage is fermented for at least 2 days to produce an alcohol content of at least 2%.

10. A beer-like beverage formed by a method according to claim 1 comprising fermented steam-cooked milled grain.

11. A method of producing a food product and a beverage comprising:
providing a supply of milled grain;
forming a dough from the milled grain by addition of water;
extruding the dough or otherwise shaping the dough under pressure;
subjecting the dough to at least partial cooking in steam;
forming a pasta-like food product from a first portion of the cooked extruded or otherwise shaped dough at a processing station;
collecting surplus or reject pasta from the processing station; and
providing the collected surplus or reject pasta to a brewing process to produce an alcoholic beverage.

12. A method according to claim 11 wherein the collected surplus or reject pasta is formed into a beverage according to a method according to claim 1.

13. (canceled)

14. A method according to claim 11 further comprising monitoring and/or predicting a quantity of surplus or reject pasta and adjusting production of the second portion in response to said monitoring or predicting.

15. A production line for producing a pasta-like product comprising:
an extruder for extruding pasta dough into a pasta-like food product or a sheeter/laminator to produce a thin sheet of pasta dough under pressure for use as pasta-like food products;
a steam cooking station for at least partially cooking the extruded or sheet pasta dough;
at least one further processing station comprising cutting, filling or packaging stations for further processing the at least partially cooked extruded or sheet pasta dough into pasta-like food product;
a collecting arrangement at which surplus or reject pasta from the at least one further processing station is collected and supplied to a brewing process including a fermenting process in which an alcoholic beverage is made from the supplied surplus or reject pasta.

16. A production line according to claim 15 including a production path for supplying the pasta production process and a bypass path for supplying gelatinized pasta to the fermentation process.

17. A production line according to claim 16 including a controller for adjusting an amount of dough supplied to the fermenting process via the bypass path in dependence on the amount collected by the collecting arrangement.

18. A production line according to claim 17 including logic for estimating or predicting the amount collected based on previous collection history and process parameters.

19. A production line according to claim 18 wherein the logic includes a machine learning engine arranged to train based on process and recipe parameters and collected amounts.

20. A production line according to claim 15, further comprising a quality control process arranged to reject partially formed pasta at one or more processing stations according to one or more quality criteria, wherein the rejected partially formed pasta is supplied as a feed to a beverage making process and wherein the quality criteria are set to target a positive non-zero proportion of rejected partially formed pasta.

21. A method according to claim 11, further comprising separately packaging the pasta-like food product and the alcoholic beverage into respective sealed pasta and drink containers, and subsequently packaging the sealed pasta and drink containers into a combined meal package.

22. (canceled)
